(19) United States
(12) Patent Application Publication
(10) Pub. No.: US 2014/0009436 A1
(43) Pub. Date: Jan. 9, 2014

(54) Sense Device and Capacitive Touch Control Display

(71) Applicant: NOVATEK MICROELECTRONICS CORP., Hsin-Chu (TW)

(72) Inventors: Chih-Chang Lai, Taichung City (TW); Shun-Li Wang, Hsinchu City (TW)

(73) Assignee: NOVATEK Microelectronics Corp., Hsin-Chu (TW)

(21) Appl. No.: 13/736,926

(22) Filed: Jan. 8, 2013

(30) Foreign Application Priority Data
Jul. 5, 2012 (TW) 101124211

(51) Int. Cl. G06F 3/044

(52) U.S. Cl. CPC G06F 3/044
USPC 345/174

(57) ABSTRACT

A sense device for a capacitive touch control display is disclosed. The sense device includes a plurality of sense channels paralleled to each other, each of the sense channel including a first sense electrode having a first geometric figure for outputting a first sense signal, a second sense electrode having a second geometric figure for outputting a second sense signal, and a third sense electrode formed between the first sense electrode and the second sense electrode for outputting a third sense signal. An operation unit of the capacitive touch control display determines a plurality of touch positions according to the first sense signal, the second sense signal and the third sense signal.

### BACKGROUND OF THE INVENTION

1. Field of the Invention

The present invention relates to a sense device and a capacitive touch control display, and more particularly, to a sense device and a capacitive touch control display capable of detecting multiple touch positions.

2. Description of the Prior Art

A touch control display device has been widely utilized among electrical products. The touch control display device includes a display panel and a transparent touch panel. Through attachment of the display panel to the transparent touch panel, the touch control display device can realize functions of touch control as well as display. Nowadays, capacitive touch control is the most popular technique.

Please refer to FIG. 1, which is a schematic diagram of a traditional capacitive touch control display 10 disclosed by U.S. Pat. No. 4,087,625. In FIG. 1, the capacitive touch control display 10 comprises a sense device 100, an operation unit 102 a flexible circuit board (not shown in figure). The sense device 100 is interlaced by Indium Tin Oxide (ITO) to form sense channels or sense array on its surface. As shown in FIG. 1, each sense channel is realized by a single-layer of paired triangles for respectively outputting sense signals S₁-S_{N} and D₁-D_{N} to the operation unit 102 via the flexible circuit board. Further more, when a human body (object) touches the touch control display device 10, the human body and the sense array form a coupling capacitor to sense capacitance changes of the coupling capacitor, such that the sense signals S₁-S_{N} and D₁-D_{N} outputted by the sense electrodes may change to accordingly compute a touch coordinate in X and Y directions. In short, the structure of the paired triangles provides a solution simplifying two-layer sense array into a single-layer sense array. By utilizing the single-layer sense array, a complex production process can be simplified, and production costs effectively controlled.

Further more, U.S. Patent Application Number 2010/0309167 A1 discloses another type of sense device 20. Please refer to FIG. 2, which is a schematic diagram of the traditional sense device 200. Comparing with the sense device 100 shown in FIG. 1, the sense device 200 adjusts the number of paired triangles to realize the single-layer sense array structure. As shown in FIG. 2, the sense electrodes of each sense channel are realized by three pairs of triangles.

However, the sense device shown in FIG. 1 or FIG. 2 can merely detect one touch position at one time, if the user touches two touch positions at a single sense channel of the sense device 100 or 200, the operation unit 102 may recognize coordinates of one of the two touch positions according to the sense signals S₁-S_{N} and D₁-D_{N}. Therefore, how to utilize the single-layer sense array to detect multiple touch positions has become a goal in the industry.

### SUMMARY OF THE INVENTION

It is therefore an object of the present invention to provide a sense device and a capacitive touch control display capable of detecting multiple touch positions.

The present invention discloses a sense device for a capacitive touch control display comprising a plurality of sense channels paralleled to each other, each of the sense channel comprising a first sense electrode having a first geometric figure for outputting a first sense signal, a second sense electrode having a second geometric figure for outputting a second sense signal, and a third sense electrode formed between the first sense electrode and the second sense electrode for outputting a third sense signal, wherein an operation unit of the capacitive touch control display determines a plurality of touch positions according to the first sense signal, the second sense signal and the third sense signal.

The present invention further discloses a capacitive touch control display comprising a sense device comprising a plurality of sense channels paralleled to each other, each of the sense channel comprising a first sense electrode having a first geometric figure for outputting a first sense signal, a second sense electrode having a second geometric figure for outputting a second sense signal, and a third sense electrode formed between the first sense electrode and the second sense electrode for outputting a third sense signal, and an operation unit for determining a plurality of touch positions according to the first sense signal, the second sense signal and the third sense signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a traditional capacitive touch control display.

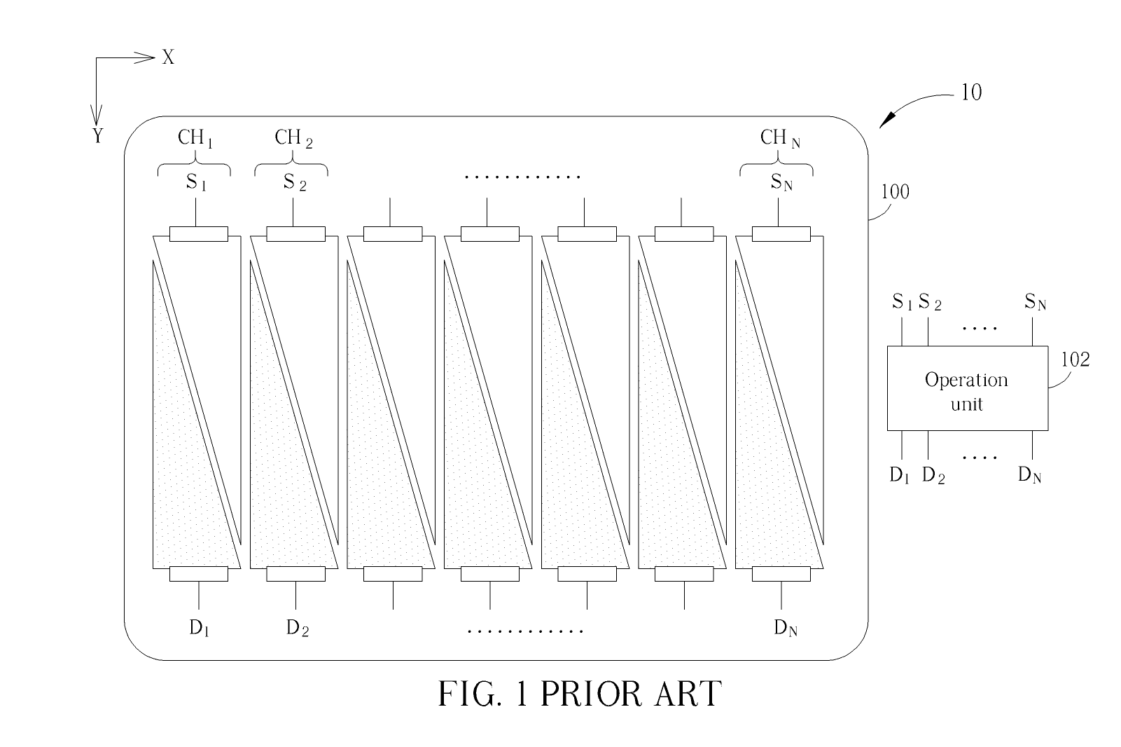

FIG. 2 is a schematic diagram of a traditional sense device.

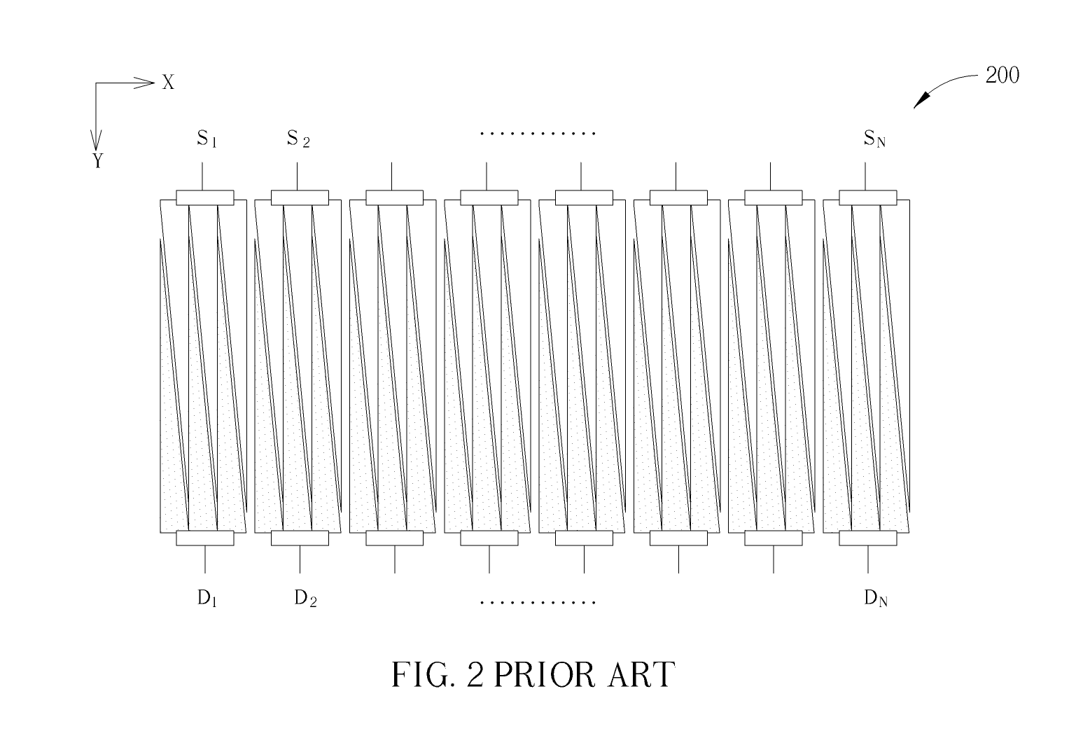

FIG. 3 is a schematic diagram of a sense device according to an embodiment of the present invention.

FIG. 4 is a schematic diagram of a sense device according to another embodiment of the present invention.

FIG. 5 is a schematic diagram illustrating the touch positions detected by the operation unit shown in FIG. 3 cooperating with the sense device shown in FIG. 3 and the sense device shown in FIG. 4.

FIG. 6 is a schematic diagram of a sense device according to another embodiment of the present invention.

FIG. 7 is a schematic diagram of a sense device according to another embodiment of the present invention.

### DETAILED DESCRIPTION

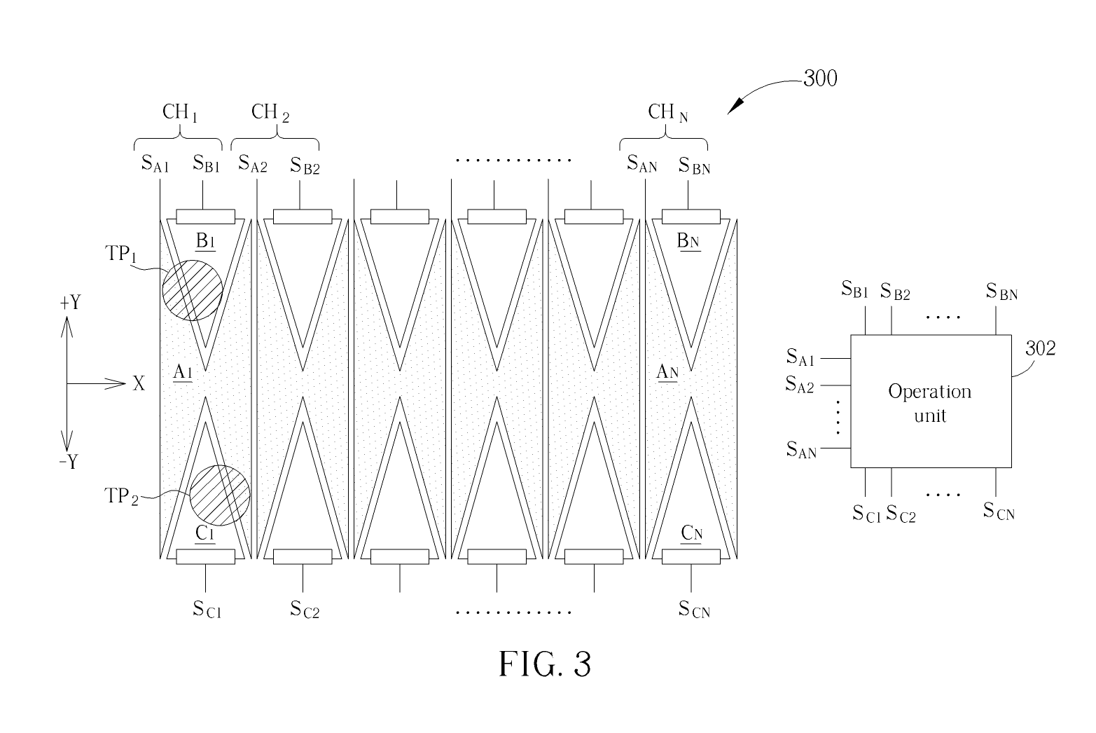

Please refer to FIG. 3, which is a schematic diagram of a sense device 300 according to an embodiment of the present invention. The sense device 300 may be substituted for the sense device 100 in the capacitive touch control display. The sense device 300 comprises sense channels CH₁-CH_{N} and an operation unit 302. Each of the sense channels CH₁-CH_{N} is paralleled to each other and has the same structure. As shown in FIG. 3, each of the sense channels CH₁-CH_{N} comprises three sense electrodes, for example, the sense channel CH₁ comprises sense electrodes A₁, B₁ and C₁, the sense channel CH₂ comprises sense electrodes A₂, B₂ and C₂, . . . , and the sense channel CH_{N} comprises sense electrodes A_{N}, B_{N} and C_{N}. In detail, the sense electrode may have a specific geometric figure. Take the sense channel CH₁ in FIG. 3 for example, the sense electrode B₁ is an equilateral triangle and the same as the sense electrode C₁, while the sense electrode A₁ is formed between the sense electrode B₁ and the sense electrode C₁. The sense electrodes A₁-A_{N}, B₁-B_{N} and C₁-C_{N} are respectively used for sensing whether the sense device 300 is touched by a human body to output sense signals S_{A1}⁻S_{AN}, S_{B1}-S_{BN} and S_{C1}-S_{CN} to the operation unit 302. The operation unit 302 is used for computing touch positions according to signal differences ΔS_{A1}−ΔS_{AN}, ΔS_{B1}−ΔS_{BN} and ΔS_{C1}−ΔS_{CN} of the sense signals S_{A1}-S_{AN}, S_{B1}-S_{BN} and S_{C1}-S_{CN} before and during the sense device 300 is touched by the human body.

In such a structure, if two fingers of a user simultaneously touch one sense channel, e.g. the sense channel CH₁, the operation unit 302 may obtain the signal differences ΔS_{A1}, ΔS_{B1} and ΔS_{C1} by comparing the sense signals S_{A1}, S_{B1} and S_{C1} before and during the sense device 300 is touched by the human body, so as to compute two touch positions TP₁ and TP₂.

In operation, if the operation unit 302 computes one of the signal differences ΔS_{A1}, ΔS_{B1} and AS_{C1} corresponding to the sense signals S_{A1}, S_{B1} and S_{C1} as greater than a threshold value, the operation unit 302 may notice a touch event at the sense channel CH₁ and obtain coordinates of the touch positions TP₁ and TP₂ in X direction according to a coordinate of the sense channel CH₁ in X direction.

Meanwhile, if the signal differences ΔS_{A1}, ΔS_{B1} of the sense signals S_{A1}, S_{B1} before and during the touch event are both greater than the threshold value, the operation unit 302 may compute a coordinate of the touch position TP₁ in +Y direction according to the signal differences ΔS_{A1}, ΔS_{B1} of the sense signals S_{A1}, S_{B1} before and during the touch events. Specifically, the closer the touch position close to the center of the sense channel CH₁, i.e. the center between +Y and −Y directions, the greater touch area of the sense electrode A₁, and the greater signal difference ΔS_{A1} of the sense signal S_{A1} before and during the touch event. In contrast, the farther the touch position is away from the center of the sense electrode CH₁, the greater touch area of the sense electrode B₁, and the greater the signal difference ΔS_{B1} of the sense signal S_{B1} before and during the touch event. As a result, the operation unit 302 may compute the coordinate of the touch position TP₁ in the +Y direction according to the signal differences ΔS_{A1}, ΔS_{B1} of the sense signals S_{A1}, S_{B1} before and during the touch event.

On the other hand, if the signal differences ΔS_{A1}, ΔS_{C1} of the sense signals S_{A1}, S_{C1} before and during the touch events are both greater than the threshold value, the operation unit 302 may compute the coordinate of the touch position TP₂ in the −Y direction according to the signal differences ΔS_{A1}, ΔS_{C1} of the sense signals S_{A1}, S_{C1} before and during the touch events. Similarly, the closer the touch position close to the center of the sense channel CH₁, i.e. the center between the +Y and −Y directions, the greater touch area of the sense electrode A₁, and the greater signal difference ΔS_{A1} of the sense signal S_{A1} before and during the touch event. In contrast, the farther the touch position is away from the center of the sense electrode CH₁, the greater touch area of the sense electrode C1, and the greater the signal difference ΔS_{C1} of the sense signal S_{C1} before and during the touch event. As a result, the operation unit 302 may compute the coordinate of the touch position TP₂ in the −Y direction according to the signal differences ΔS_{A1}, ΔS_{C1} of the sense signals S_{A1}, S_{C1} before and during the touch event.

In short, the sense device 300 of the present invention may generate sense signals by the three sense electrodes of each sense channel, such that the sense device 300 may detect multiple touch positions at once with a structure of a single-layer sense array.

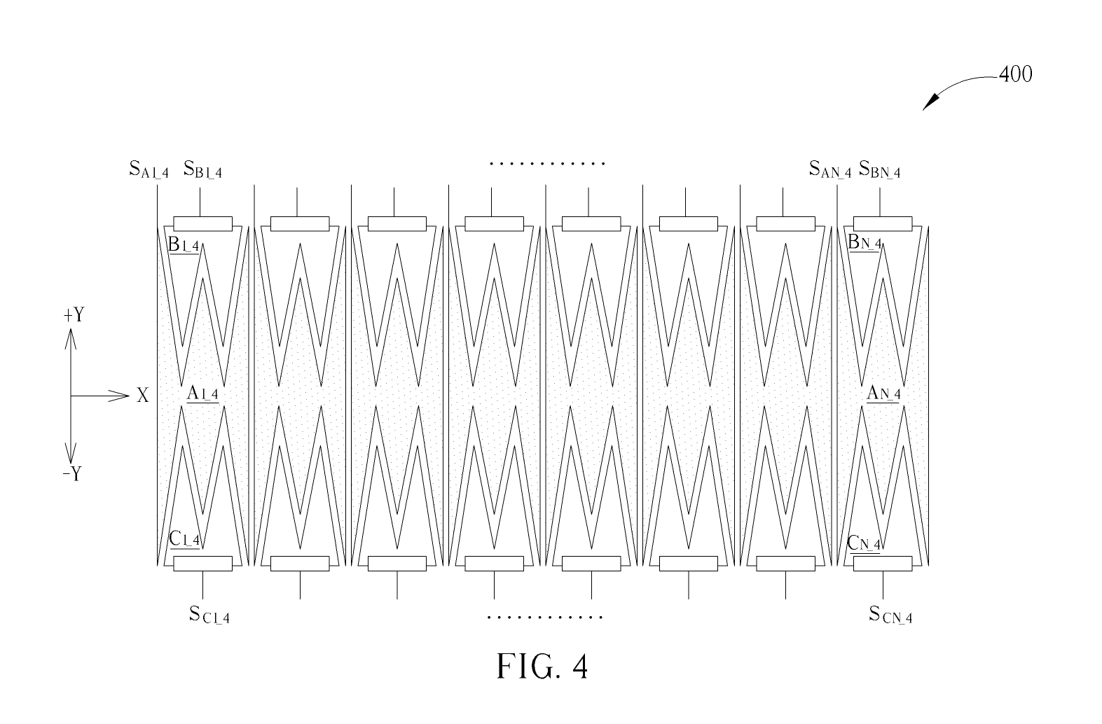

Moreover, in order to improve sensitivities of the sense electrodes B₁-B_{N} and C₁-C_{N} to detect the touch positions, preferably, the sense electrodes B₁-B_{N} and C₁-C_{N} may have the same geometric figure and the same area. For example, please refer to FIG. 3 and FIG. 4 at the same time, FIG. 4 is a schematic diagram of a sense device 400 according to another embodiment of the present invention. Take channel CH₁ for instance, the geometric figure of the sense electrodes B₁ and C₁ in FIG. 3 is an equilateral triangle with the same area. In FIG. 4, the geometric figure of the sense electrodes B₁_{_{—}}₄ and C₁_{_{—}}₄ is a convex saw-tooth formed by connecting two equilateral triangles side by side, such that the sensitivities of the sense electrodes A₁_{_{—}}₄, B₁_{_{—}}₄ and C₁_{_{—}}₄ may be more even, and improve an accuracy of the sense device 400 for detecting the coordinate of the touch position in the +Y and −Y directions.

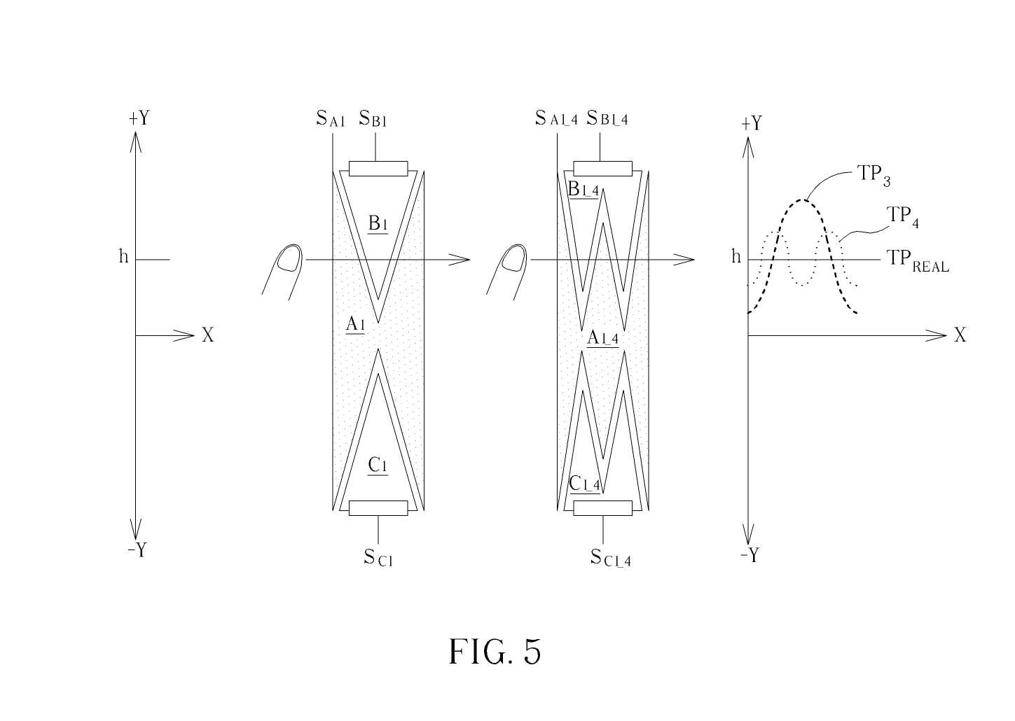

Please refer to FIG. 5, which is a schematic diagram illustrating the touch positions detected by the operation unit 302 cooperating with the sense device 300 and 400. Assume that the user slides a horizontal line, i.e. touch position TP_{REAL} denoted with a solid line, from the coordinate h of the X direction along the +Y direction on the sense devices 300 and 400, respectively. The operation unit 302 computes the touch position TP₃ denoted with a dash line according to the sense signals S_{A1} and S_{B1} outputted by the sense device 300. The operation unit 302 computes the touch position TP₄ denoted with a dotted line according to the sense signals S_{A1}_{_{—}}₄ and S_{B1}_{_{—}}₄ outputted by the sense device 400. As shown in FIG. 5, if most of the touch position TP_{REAL} lies in the area of the sense electrode B₁ and only small part of the touch position TP_{REAL} lies in the area of the sense electrode A₁, the signal difference ΔS_{B1} of the sense signal S_{B1} may be much greater than the signal difference ΔS_{A1} of the sense signal S_{A1} before and during the touch event, such that the touch position TP₃ computed by the operation unit 302 may be greater than the coordinate h, which causes the sense device 300 may have greater coordinate errors in the +Y direction. In comparison, the touch position TP_{REAL} may be located evenly between the areas of the sense electrodes A₁_{_{—}}₄ and B₁_{_{—}}₄ since the areas of the sense electrodes A₁_{_{—}}₄ and B₁_{_{—}}₄ are more evenly distributed than the areas of the sense electrodes A₁ and B₁. As a result, the signal differences ΔS_{A1}_{_{—}}₄ and ΔS_{B1}_{_{—}}₄ of the sense signals S_{A1}_{_{—}}₄ and S_{B1}_{_{—}}₄ before and during the touch event may be even, such that the touch position TP₄ computed by the operation unit 302 may be close the real touch position TP_{REAL} and the sense device 400 may have smaller coordinate errors in the +Y and −Y directions.

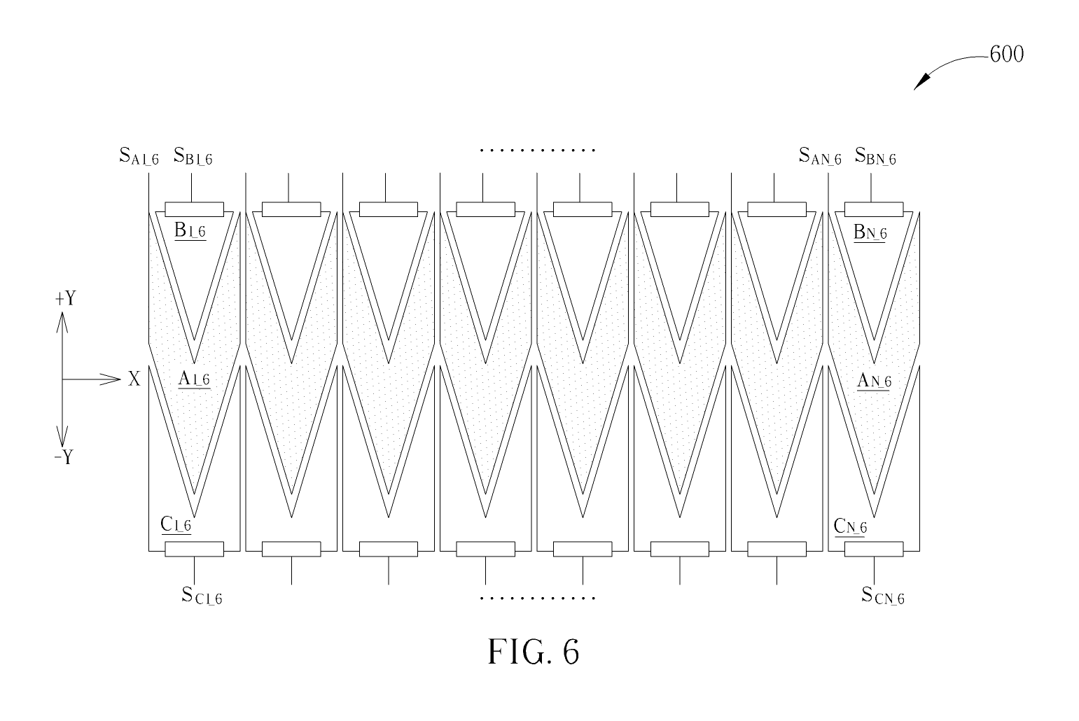

On the other hand, the geometric figures of the sense electrodes B₁ and C₁ in the sense channel CH₁ and the geometric figures of the sense electrodes B₁_{_{—}}₄ and C₁_{_{—}}₄ in the sense channel CH₁₋₄ maybe different. For example, please refer to FIG. 6, which is a schematic diagram of a sense device 600 according to an embodiment of the present invention. In FIG. 6, the geometric figure of the sense electrode B₁_{_{—}}₆ is an equilateral triangle, and the geometric figure of the sense electrode C₁_{_{—}}₆ is a concave saw-tooth corresponding to the equilateral triangle of the sense electrode B₁_{_{—}}₆, wherein the area of the sense electrode B₁_{_{—}}₆ is preferably equal to the area of the sense electrode C₁_{_{—}}₆. In such a structure, the sense electrodes B₁_{_{—}}₆ and C₁_{_{—}}₆ may have the same sensitivity though those geometric figures are different.

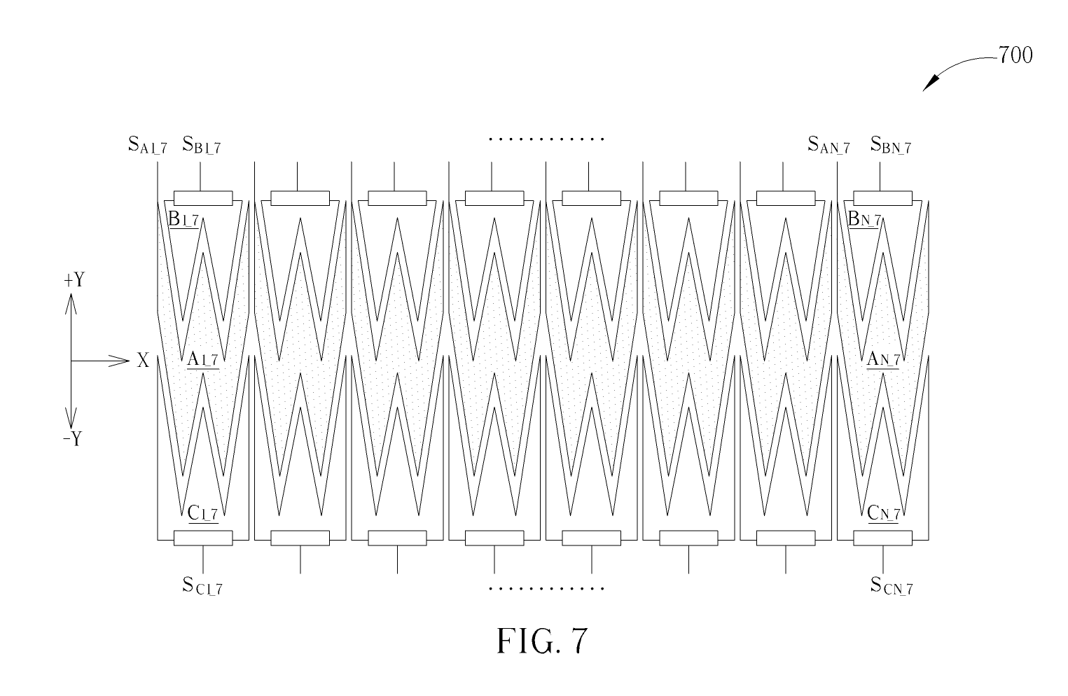

Please refer to FIG. 7, which is a schematic diagram of a sense device 700 according to an embodiment of the present invention. As shown in FIG. 7, the sense electrode B₁_{_{—}}₇ and the sense electrode B₁_{_{—}}₄ have the same geometric figure, which is a convex saw-teeth formed by connecting a plurality of equilateral triangles side by side. The geometric figure of the sense electrode C₁_{_{—}}₇ is derived from the geometric figure of the sense electrode C₁_{_{—}}₆, the geometric figure of the sense electrode C₁_{_{—}}₇ is concave saw-teeth corresponding to the geometric figure of the sense electrode B₁_{_{—}}₇, and is formed by connecting a plurality of concave saw-teeth side by side. Likewise, the sense electrodes A₁_{_{—}}₇, B₁_{_{—}}₇ and C₁_{_{—}}₇ may have the same sensitivity thought their geometric figures are different. Also, the areas of the sense electrodes A₁_{—7}, B₁_{_{—}}₇ and C₁_{_{—}}₇ are more evenly distributed than the areas of the sense electrodes A₁_{_{—}}₆, B₁_{_{—}}₆ and C₁_{_{—}}₆ to detect the touch coordinate precisely.

To sum up, the traditional sense devices 100 and 200 may only detect a single touch position at once. In comparison, the sense devices 300, 400, 600 and 700 of the present invention may detect multiple touch positions simultaneously. Furthermore, sense electrode of the sense device may have various geometric figures to reach different levels of coordinate accuracy. As a result, the present invention may achieve multiple touch detection and well coordinate accuracy with the simple structure of the single-layer sense array.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sense device for a capacitive touch control display comprising
a plurality of sense channels paralleled to each other, each of the sense channel comprising:
a first sense electrode having a first geometric figure for outputting a first sense signal;
a second sense electrode having a second geometric figure for outputting a second sense signal; and
a third sense electrode formed between the first sense electrode and the second sense electrode for outputting a third sense signal;
wherein an operation unit of the capacitive touch control display determines a plurality of touch positions according to the first sense signal, the second sense signal and the third sense signal.

2. The sense device of claim 1, wherein the first geometric figure and the second geometric figure are the same.

3. The sense device of claim 2, wherein the first geometric figure is an equilateral triangle.

4. The sense device of claim 2, wherein the first geometric figure is formed by connecting a plurality of equilateral triangles side by side.

5. The sense device of claim 1, wherein the first geometric figure and the second geometric figure are different.

6. The sense device of claim 5, wherein the first geometric figure is an equilateral triangle.

7. The sense device of claim 5, wherein the second geometric figure is a concave saw-tooth corresponding to the first geometric figure.

8. The sense device of claim 5, wherein the first geometric figure is a convex saw-teeth formed by connecting a plurality of equilateral triangles side by side.

9. The sense device of claim 5, wherein the second geometric figure is formed by connecting a plurality of concave saw-teeth side by side.

10. A capacitive touch control display comprising:
a sense device comprising a plurality of sense channels paralleled to each other, each of the sense channel comprising:
a first sense electrode having a first geometric figure for outputting a first sense signal;
a second sense electrode having a second geometric figure for outputting a second sense signal; and
a third sense electrode formed between the first sense electrode and the second sense electrode for outputting a third sense signal; and
an operation unit for determining a plurality of touch positions according to the first sense signal, the second sense signal and the third sense signal.

11. The capacitive touch control display of claim 10, wherein the first geometric figure and the second geometric figure are the same.

12. The capacitive touch control display of claim 11, wherein the first geometric figure is an equilateral triangle.

13. The capacitive touch control display of claim 11, wherein the first geometric figure is formed by connecting a plurality of equilateral triangles side by side.

14. The capacitive touch control display of claim 10, wherein the first geometric figure and the second geometric figure are different.

15. The capacitive touch control display of claim 14, wherein the first geometric figure is an equilateral triangle.

16. The capacitive touch control display of claim 14, wherein the second geometric figure is a concave saw-tooth corresponding to the first geometric figure.

17. The capacitive touch control display of claim 14, wherein the first geometric figure is a convex saw-teeth formed by connecting a plurality of equilateral triangles side by side.

18. The capacitive touch control display of claim 14, wherein the second geometric figure is formed by connecting a plurality of concave saw-teeth side by side.
